(19) United States
(12) Patent Application Publication
(10) Pub. No.: US 2007/0275705 A1
(43) Pub. Date: Nov. 29, 2007

(54) Systems and methods for managing content for mobile devices

(76) Inventors: Allen Lau, Markham (CA); Troy Hubman, Toronto (CA)

Correspondence Address: BERESKIN AND PARR, 40 KING STREET WEST, BOX 401, TORONTO, ON, M5H 3Y2, CA

(21) Appl. No.: 11/802,788

(22) Filed: May 25, 2007

Related U.S. Application Data
(60) Provisional application No. 60/808,539, filed on May 26, 2006.

(51) Int. Cl. H04Q 7/38

(52) U.S. Cl. 455/414.1

(57) ABSTRACT

Systems and methods of retrieving information from a web site accessible to mobile devices are disclosed. The web site has a first content set restricted to a first mobile device and a second content set restricted to a second different mobile device. The system includes a crawler running on a computing device which sends a request to the web site. The request includes a header identifying the computing device as the first mobile device. The crawler alters the header so that the web site processes the request as if it was sent from the second mobile device.

### CROSS-REFERENCE TO RELATED APPLICATIONS

This application claims priority to U.S. Provisional Application No. 60/808,539 filed on May 26, 2006, which is incorporated by reference herein in its entirety.

### FIELD OF THE INVENTION

The invention relates to storing and managing content, and in particular, to systems and methods for managing different types of content for mobile devices.

### BACKGROUND OF THE INVENTION

The success of the market for mobile devices has created a number of problems for mobile network operators, publishers, and other providers of content for mobile devices.

The mobile device market is approaching 1,000 devices with varying screen sizes, input interfaces, as well as graphics, and processing capabilities. The mobile devices range from entry level up to expensive smart phones and personal digital assistants (PDAs). This trend, where hundreds of different mobile devices are released each year, is referred to in the industry as “device fragmentation”.

One of the most common types of content for mobile devices is game application content. Mobile device video game publishers typically create and publish a game for a single type of mobile device. This version is referred to as a reference build. The reference build may have to be adapted for a number of other mobile devices (referred to as “target devices”). The adaptation of a reference build to a target device is known as “porting” and the ported application is referred to as a “target build”. The publisher may itself attempt to port a particular game application, or may outsource the porting task to a third party.

In addition, certain network operators require customizations to mobile device content, such as games, offered on devices used by their subscribers. These customizations require changes to the content file. For example, each operator may have its own naming convention and require all builds submitted to have a file name that satisfies such naming conventions. Other operators may require submitted builds to incorporate certain application program interfaces (APIs). These customizations are collectively referred to as “channel packaging”. Each unique permutation of a target build adapted for the requirements of a specific operator is referred to as a “channel-ready build”. These channel-ready builds, reference builds and target builds may be collectively referred to simply as “builds”.

There are currently about 700 network operators worldwide. The process of porting a reference build for different target devices and accommodating channel packaging requirements of the various network operators may lead to literally thousands of target builds for each reference build. The total number of builds multiplies with each different game developed by publishers.

In addition to the large number of builds, operators have unique submission requirements which do not require alteration of the game application files. For example, an operator may require a text file describing a game, screen shots, or an AVI (animation) file to be submitted with the game.

The publishers are motivated to create (or retain others to create) the numerous target builds because it is the only way they can maximize the revenue generated from a particular game (which depends on the number of devices on which the game has been loaded). Due to device fragmentation, restricting the game to a particular device will only allow a game to reach a small portion of the mobile device market.

Mobile device content, such as games, is offered for download (typically for a fee) by mobile network operators or independent business entities (i.e. those that do not operate mobile networks but simply provide websites and software for mobile devices). These independent business entities are referred to as “off-portals”.

Both the network operators and off-portals present the mobile device content on a Wireless Application Protocol (WAP) site. The off-portals' WAP sites are available to any Internet-enabled mobile device.

Typically, the network operators' WAP sites cannot be accessed over the open Internet. In particular, such sites cannot be accessed from personal computers or from mobile devices of subscribers of other networks. The WAP site of a particular network operator can typically only be accessed from a device of a subscriber of the network operator.

A network operator's WAP site contains a list of games available for download in a particular order. This list is referred to as the network operator's “WAP deck”. The order of the games on the WAP deck is important, as the number of downloads are highest for games at the top of the WAP deck and decrease significantly toward the bottom of the WAP deck. The order of the games on the WAP deck is referred to as “deck placement”.

In addition, the WAP deck is different for each mobile device available on the network operator's network. The WAP site serves a different page to each type of mobile device available on the operator's network. Each page may have a different WAP deck which reflects the different games available for a particular type of mobile device. Consequently, a subscriber with one type of mobile device typically cannot access the page of the operator's WAP site corresponding to another type of mobile device.

Accordingly, there is a need for systems and methods of managing content, such as games, for mobile devices. In particular, there is a need for systems and methods for storing the mobile device content and information about each item of the mobile device content. There is also a need for systems and methods which can determine which content is not offered by particular network operators and off-portals and deliver such missing content to the network operators and off-portals. There is also a need for systems and methods for determining the deck placement of a content item. There is also a need for systems and methods for searching for mobile content and presenting locations where mobile content may be downloaded.

### SUMMARY OF THE INVENTION

According to a first aspect of the invention, a system for managing a plurality of mobile content items is provided. The system comprises:

a) a storage module adapted to store the plurality of mobile content items, wherein the storage module is adapted to store metadata for each of at least a portion of the plurality of mobile content items, the metadata comprising at least one of device-specific information and channel-specific information; and

b) a processing module adapted to use the metadata to identify particular mobile content items meeting predetermined criteria, wherein the predetermined criteria comprise at least one of device-specific criteria and channel-specific criteria.

According to a second aspect of the invention, a method of managing a plurality of mobile content items is provided. The method comprises:

a) associating metadata with each of at least a portion of the plurality of mobile content items, the metadata comprising at least one of device-specific information and channel-specific information; and

b) retrieving a selected one of the plurality of mobile content items which matches predetermined criteria using the metadata associated with the selected mobile content item.

According to a third aspect of the invention, a system for retrieving information from a web site accessible to mobile devices is provided. The web site has a first content set restricted to a first mobile device and a second content set restricted to a second different mobile device. The system comprises a crawler running on a computing device which is adapted to send a request to the web site. The request comprises a header identifying the computing device as the first mobile device, wherein the crawler is adapted to alter the header so that the web site processes the request as if it was sent from the second mobile device.

According to a fourth aspect of the invention, a method of retrieving information from a web site accessible to mobile devices is provided. The web site has a first content set restricted to a first mobile device and a second content set restricted to a second different mobile device. The method comprising:

a) sending a first request to the web site, wherein the first request comprises a header identifying the first mobile device;

b) creating a second request by changing the header of the first request to identify the second mobile device; and

c) sending the second request to the web site.

### BRIEF DESCRIPTION OF THE DRAWINGS

In the accompanying drawings:

FIG. 1 is a schematic diagram of a mobile content management system according to an exemplary embodiment of the present invention;

FIG. 2 is a flow chart illustrating a method of managing content for mobile devices according to an embodiment of the present invention; and

FIG. 3 is a flow chart illustrating a method of gathering information about available mobile device content according to an embodiment of the present invention.

### DETAILED DESCRIPTION OF THE INVENTION

It will be appreciated that for simplicity and clarity of illustration, where considered appropriate, numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing the implementation of the various embodiments described herein.

The embodiments of the systems and methods described herein may be implemented in hardware or software, or a combination of both. However, preferably, these embodiments are implemented in computer programs executing on programmable computers each comprising at least one processor, a data storage system (including volatile and non-volatile memory and/or storage elements), at least one input device, and at least one output device. For example and without limitation, the programmable computers may be a personal computer, laptop, personal data assistant, and cellular telephone. Program code is applied to input data to perform the functions described herein and generate output information. The output information is applied to one or more output devices, in known fashion.

Each program is preferably implemented in a high level procedural or object oriented programming and/or scripting language to communicate with a computer system. However, the programs can be implemented in assembly or machine language, if desired. In any case, the language may be a compiled or interpreted language. Each such computer program is preferably stored on a storage media or a device (e.g. ROM or magnetic diskette) readable by a general or special purpose programmable computer, for configuring and operating the computer when the storage media or device is read by the computer to perform the procedures described herein. The inventive system may also be considered to be implemented as a computer-readable storage medium, configured with a computer program, where the storage medium so configured causes a computer to operate in a specific and predefined manner to perform the functions described herein.

Furthermore, the system, processes and methods of the described embodiments are capable of being distributed in a computer program product comprising a computer readable medium that bears computer usable instructions for one or more processors. The medium may be provided in various forms, including one or more diskettes, compact disks, tapes, chips, wireline transmissions, satellite transmissions, internet transmission or downloading, magnetic and electronic storage media, digital and analog signals, and the like. The computer useable instructions may also be in various forms, including compiled and non-compiled code.

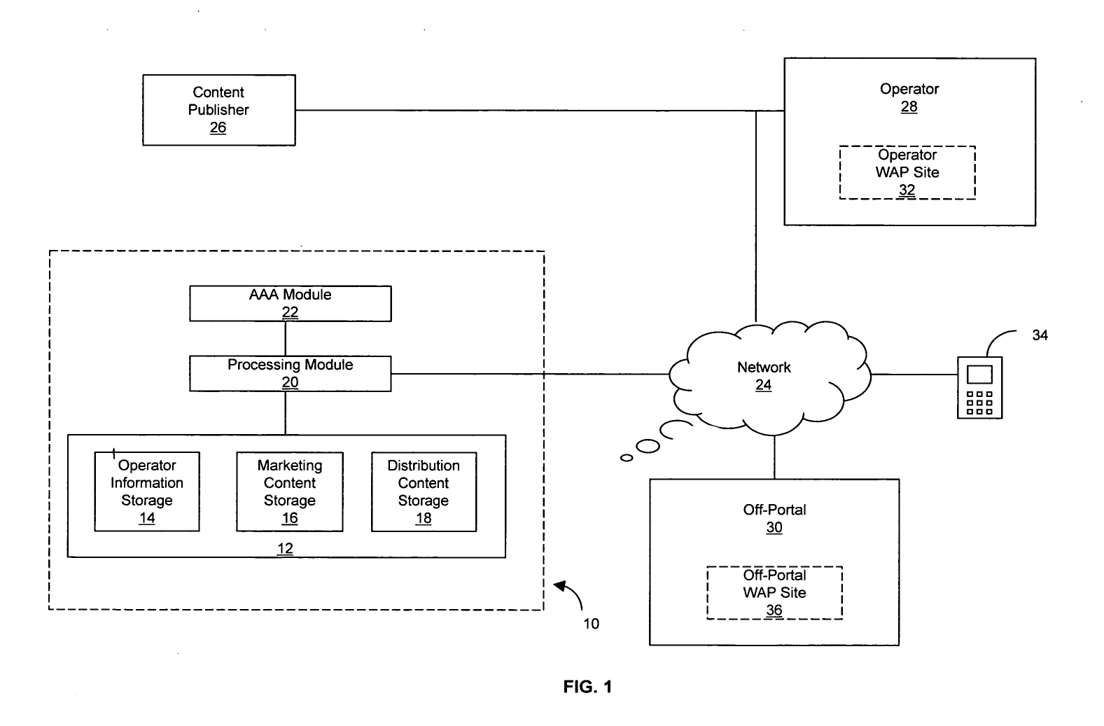

FIG. 1 shows a system 10 for managing mobile device content according to an exemplary embodiment of the present invention. As used herein “mobile device content”, “mobile content items” or simply “content” means any digital content capable of being output by a mobile device, including without limitation wallpapers or other images, ring tones or other sound effects, screen savers, video clips, and applications (including games). For convenience, the description below will focus on game applications as an exemplary type of content. However, those skilled in the art will understand that such references are not intended to limit the scope of the present invention to game application content.

As used herein, “mobile device” means any computing device which has input, output, or processing constraints relative to a desktop or laptop computer. Mobile devices include without limitation cellular phones, personal email devices, personal and digital assistants (PDAs), pagers, set-top boxes, and in-vehicle telematic systems.

Referring to FIG. 1, the content management system 10 includes a processing module 20 which is in communication with a storage module 12 and an authentication, authorization, and accounting (AAA) module 22.

The storage module 12 stores the mobile content. The storage module 12 is further subdivided into a operator information storage 14, marketing content storage 16, and distribution content storage 18. Each of these sub-modules store different types of content. The operator information storage 16 stores the site map information and deck placement information for the WAP sites of various network operators, such as network operator 28. The marketing content storage 16 may store various marketing content items required for submission requirement of various network operators, including without limitation, user guides, screen shots, and video clips for game applications. The distribution content storage 18 stores all of the builds for the content managed by content management system 10, as well as metadata about each build. Each build is preferably a mobile device content item.

The metadata may be any information about a particular reference build, target build, or channel ready-build. Metadata may include but is not limited to the following information:

Name or title;

Category/Genre/Property;

Type;

Description;

Size;

Status;

Date Created;

Date Modified;

Locale;

Owners/Assignee;

Channels Deployed;

Devices Supported;

Security Level;

Keyword(s);

Cost;

Deadline;

Priority;

MSRP;

Comments; and

Operator-specific APIs and network APIs.

Any metadata (whether or not listed above) which relates to the mobile device supported by a particular mobile content item will be referred to herein as device-specific information. Any metadata (whether or not listed above) which relates to information specific to one or more network operator 28 (described below) or an off-portal 30 (described below) will be referred to herein as channel-specific information.

The storage module 12 may be implemented in any suitable manner, such as using relational databases. It will be understood by those skilled in the art that the operator information storage 14, marketing content storage 16, and distribution content storage 18 may be implemented in separate databases or may be combined in one or more database.

The processing module 20 is preferably a server which processes incoming requests for the mobile content stored in storage module 12 and initiates outgoing requests (as described in more detail below). The processing module 20 communicates with the AAA module 22 to authenticate parties with which the processing module communicates. The processing module 20 also queries the storage module 12 to manage stored content.

The AAA module 22 is also preferably a server. It will be understood by those skilled in the art that the AAA module 22 and processing module 20 may be implemented on separate servers or may be combined in a single server.

The processing module 20 of the content management system 10 may communicate via a network 24 with one or more of a content publisher 26, a server operated by the network operator 28, and a server operated by the off-portal 30. Preferably, the network 24 is the Internet, but it may be any other suitable network (such as a LAN, WAN, or the like).

As used herein, the “content publisher” 26 is a publisher of mobile content. One example of a content publisher 26 is a video game publisher. The content publisher 26 may communicate with the content management system 10 via the network 24 using a web browser or any other known communication interface. The communication may be conducted using FTP, HTTP, or SSL over HTTP. For convenience, only one content publisher 26 is shown. However, those skilled in the art will understand that the content manager system 10 may communicate with any number of content publishers. The content publisher 26 may select a content item to be submitted by the content management system 10 to a particular network operator on a case-by-case basis and manually request that the content management system 10 submit such content item. Alternatively, the content management system 10 may, with the consent of the publisher 26, discover (as described in detail below) that a particular network operator does not have a particular build which is stored in storage module 12, and automatically submit such build to the network operator.

As used herein, a “network operator” is an organization that provides carrier services (network services) in the wired or wireless arena to subscribers using mobile devices. Examples of network operators include without limitation cellular network operators and ISPs. The network operator 28 may operate a server which is capable of communication with the content management system 10.

As used herein, an “off-portal” is any organization which offers mobile device content for download to users of mobile devices. Typically, such off-portals operate servers which host WAP sites (such as the off-portal WAP site 36) that are open to any Internet-enabled mobile device regardless of the network operator to which such device subscribes. For convenience, only one off-portal 30 is shown. However, those skilled in the art will understand that the content manager system 10 may communicate with any number of servers operated by any number of off-portals.

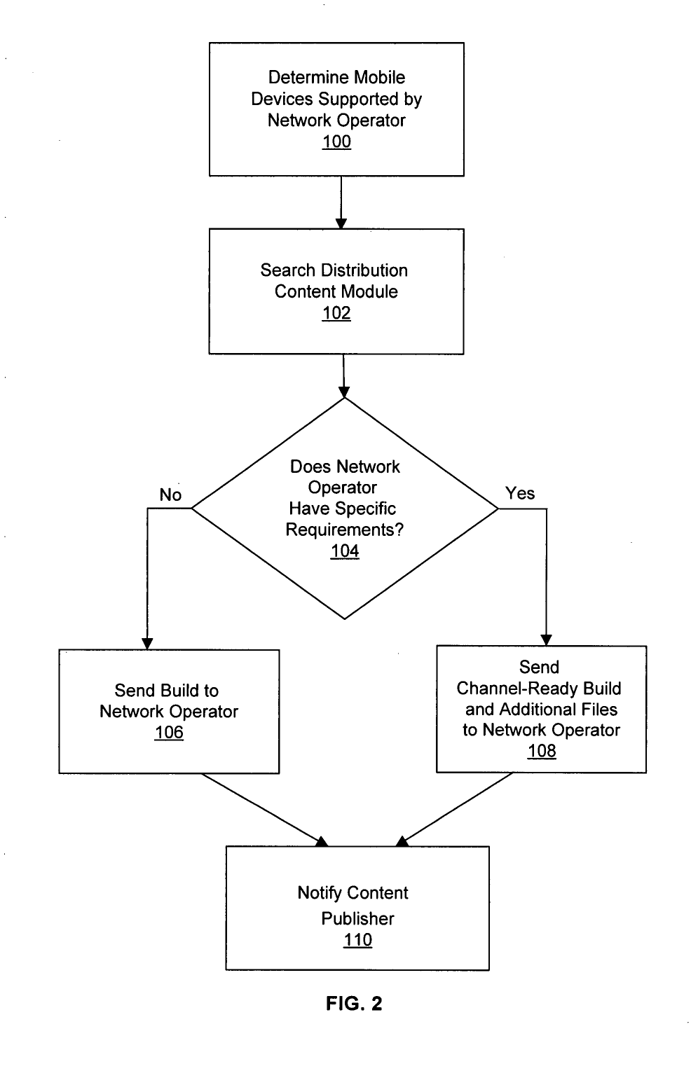

The method of operation of an exemplary embodiment of the present invention will now be described with reference to FIGS. 1 and 2.

At step 100, the operator of the content management system 10 may obtain information from one or more network operators 28 about the various mobile devices supported by such operators and the different types of content available from a particular network operator for the various mobile devices supported by such operator. For example, the operator of the content management system 10 may obtain information that a particular network operator supports the Nokia™ S-60 mobile phone, but does not offer the Powershot Hockey™ game application for download to its Nokia™ S-60 users.

At step 102, the processing module 20 searches the distribution content storage 18 of the storage module 12 for the build of Powershot Hockey™ for the Nokia™ S-60. In order to locate the required build, the processing module 20 searches the metadata associated with the builds stored in the distribution content storage 18. In this example, the device-specific criteria for the metadata search is to find the builds which support the Nokia™ S-60.

At decision diamond 104, it is determined whether the particular network operator has specific requirements for submission of game application content. If there are no specific requirements, the method moves to step 106, where the processing module 20 sends the Nokia™ S-60 build to the server operated by the network operator 28.

At step 110, the processing module 20 also sends a message to the content publisher 26 of Powershot Hockey™ in order to inform the publisher that a target build has been delivered to the server operated by the network operator 28. The content publisher 26 may use this information to update its records.

If the network operator has specific requirements for games submitted to it and other submission requirements, the method moves to step 108, where further metadata searches may be carried out to determine if the distribution content storage 18 contains a channel-ready build of Powershot™ Hockey for the Nokia™ S-60 which meets the operator's requirements, and whether the marketing content storage 18 has the additional files required by the submission requirements. The information on the channel and submission requirements of the network operator 28 may be received from the operator or may be stored in the storage module 12 of the content storage 10. The channel-ready build and any additional files required by the submission requirements are then sent to the server operated by the network operator 28. The method then moves to step 110 described above.

In an alternative embodiment of the invention, the server operated by the network operator 28 may be enabled to periodically check whether the operator's WAP site 32 has, for a particular game, all builds for each of the mobile devices the operator supports. The server operated by the network operator 28 may then send a request to the content management system 10 for any such builds. The processing module 20 would first communicate with the AAA module 22 to authenticate the request. The processing module 20 may then search the storage module 12 for builds which match the device-specific and channel-specific criteria in the request from the network operator 28.

In another alternative embodiment of the invention, the processing module 20 may periodically query the operator WAP site 32 to inventory the various mobile devices supported and the target builds and/or channel-ready builds available for download. The processing module 20 of the content management system 10 then uses this information to search the distribution content storage 18 to determine if any builds which are not being offered by on the operator's WAP site 32 are stored in distribution content storage 18. The processing module 20 would then retrieve such builds and send them to the server operated by the network operator 28, where the operator would upload it to the operator WAP site 32 using any suitable means.

The above embodiment requires the consent of the network operator 28 and the operator of the content management system 10 to permit their respective servers to communicate electronically. In the event that such consent has not been provided, alternative systems and methods may be utilized to obtain information about the target builds available for download by a particular operator.

In an alternative embodiment of the invention, a mobile device 34 is provided. The mobile device 34 subscribes to the network of the network operator 28 which operates the operator WAP site 32. In one example, the mobile device is a Nokia™ S-60 mobile phone. A Web crawling application may be loaded on the mobile device 34. Preferably, the web crawling application is similar to conventional crawlers used by Internet search engines, except as discussed below.

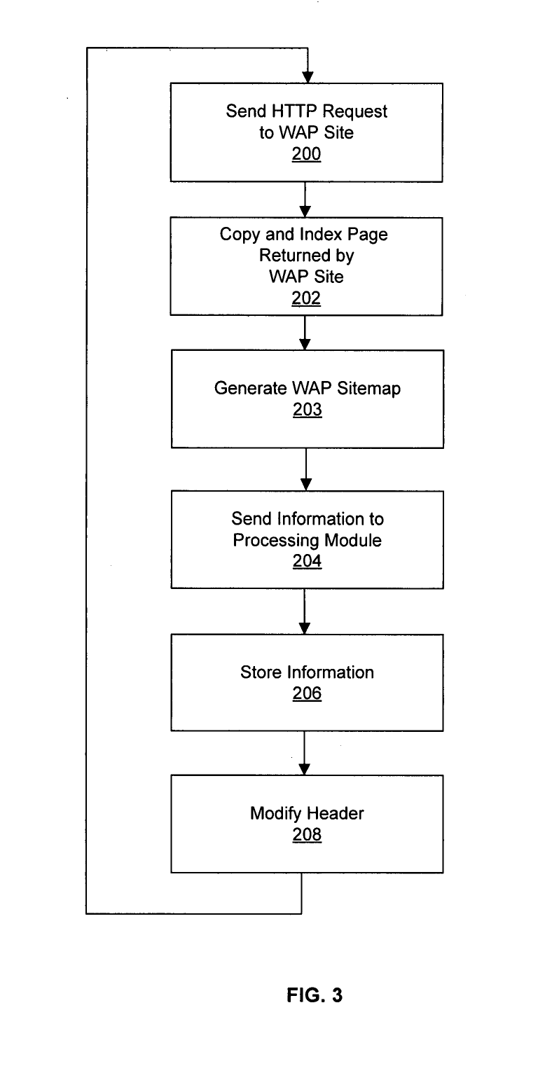

The method according to the alternative embodiment of the invention will now be described with reference to FIGS. 1 and 3.

At step 200, the web crawling application on the mobile device 34 sends a HTTP request to the operator WAP site 32. Typically, the header of the HTTP request for a particular mobile device identifies the particular device to the operator WAP site 32. As discussed above, the server at the network operator 28 reads the HTTP header and identifies the devices as a Nokia™ S-60. The operator's WAP site 32 returns the page containing the WAP deck for the Nokia™ S-60.

At step 202, this page may then be copied and indexed by the crawling application of the mobile device 34. At step 203, a device-specific WAP sitemap may be generated by the crawling application for each portion of the operator WAP site 32. At step, 204, the information gathered by the crawling application on mobile device 34 may be sent to processing module 20. At step 206, the processing module 20 stores the information in the operator information storage 14.

In order to crawl the WAP decks for all other types of mobile devices supported by the network operator 28, the header on subsequent HTTP requests to the operator WAP site 32 is modified at step 208. Specifically, the user-agent field of the HTTP request (which identifies the mobile device as a Nokia™ S-60) is changed to the field which corresponds to another device (such as a Motorola Razr™). The method flow then returns to step 200. In this manner, the HTTP request can be changed to mimic requests sent by all of the various mobile devices supported by the network operator 28. This, in turn, permits one mobile device 34 to crawl all of the WAP decks (for various different mobile devices) available on the operator WAP site 32 in order to determine the mobile device content available (and conversely the content which is not available) on such WAP decks, as well as the ranking of the content.

The mobile device may also crawl the various WAP decks of the off-portal WAP site 36 of the off-portal 30 in the same manner as described above.

The information gathered by the crawling application running on the mobile device 34 may then be sent to the processing module 20 of content management system 10 to provide information as to which builds may be suitable for submission to the network operator 28.

In another alternative embodiment of the present invention, the crawler application may reside on a PC or a desktop computer that connects to the mobile device. In this embodiment, the mobile device acts as a modem which enables the PC or desktop computer to access the Internet via the wireless network using the WAP gateway/protocol. In this manner, the crawling application may access various WAP decks from the desktop computer or PC.

In an alternative embodiment of the present invention, the content management system 10 may host a search engine website. Preferably, the search engine website will be accessible only to mobile devices. In an exemplary embodiment, the search engine website may be a WAP site.

The search engine website permits a user of an Internet-enabled mobile device to search for mobile device content items. In one example, the search engine provides the capability for a user of the mobile device to search for a particular game for download. The search engine may identify the model of the user's mobile device either by requesting the user to provide the name and model number of the device or automatically by detecting the mobile device model from the header of the HTTP request (as discussed above). Consequently, the search engine will return only website locations where games for that particular device are offered for download.

The data used searched by the search engine to produce the result may be data produced by the crawling method described above and may be stored in the network information storage 14 of storage module 12.

The search engine may also rank the hits sent to the mobile device 34 in a particular order. In one embodiment, the search engine may first display the hits from the user's operator WAP site 32, followed by the location of games in the distribution content storage 18 (if such content is made available via the Internet). The search engine may give the lowest rank to hits from off-portals. In alternative embodiments, the above ranking order may be modified based on fee-paying arrangements with various web site operators. For example, off-portal web sites may be given a higher rank if they pay the operator of the content management system 10. In addition, the rank given may be correlated to the amount paid (i.e. the higher the amount, the higher the rank).

In another alternative embodiment of the present invention, the storage module 12 may not be under the control of a single operator. The storage module 12 may be a collection of distributed storage modules, such as databases or the like. These distributed storage modules may be under the control of various parties, such as content publishers, network operators, or off-portals. The processing module 20 may query these distributed storage modules over the network 24, such as for example, the Internet.

While the present invention as herein shown and described in detail is fully capable of attaining the above-described objects of the invention, it is to be understood that it is the presently preferred embodiment of the present invention and thus, is representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural and functional equivalents to the elements of the above-described preferred embodiment that are known or later come to be known to those of ordinary skill in the art are expressly incorporated herein by reference and are intended to be encompassed by the present claims. Moreover, it is not necessary for a device or method to address each and every problem sought to be solved by the present invention, for it is to be encompassed by the present claims.

1. A system for retrieving information from a web site accessible to mobile devices, the web site having a first content set restricted to a first mobile device and a second content set restricted to a second different mobile device, the system comprising:
a crawler running on a computing device, the crawler being adapted to send a request to the web site, the request comprising a header identifying the computing device as the first mobile device, wherein the crawler is adapted to alter the header so that the web site processes the request as if it was sent from the second mobile device.

2. The system of claim 1, wherein the computing device comprises the first mobile device.

3. The system of claim 1, wherein the computing device comprises a personal computer.

4. The system of claim 2, wherein the request is a HTTP request.

5. The system of claim 4, wherein the header is a HTTP header.

6. The system of claim 5, wherein the web site is a WAP site.

7. The system of claim 6, wherein the web site is a network operator website.

8. A method of retrieving information from a web site accessible to mobile devices, the web site having a first content set restricted to a first mobile device and a second content set restricted to a second different mobile device, the method comprising:
a) sending a first request to the web site, wherein the first request comprises a header identifying the first mobile device;
b) creating a second request by changing the header of the first request to identify the second mobile device; and
c) sending the second request to the web site.

9. The method of claim 8, wherein the first and second requests are HTTP requests.

10. The method of claim 9, wherein the header is a HTTP header.

11. The method of claim 10, wherein the creating step further comprises changing a user-agent field of the HTTP header.

12. The method of claim 11, further comprising copying and indexing information received in response to the first request.

13. The method of claim 12, further comprising copying and indexing information received in response to the second request.

14. The method of claim 10, wherein the web site is a WAP site.

15. The method of claim 14, wherein the web site is a network operator website.

16. The method of claim 12, further comprising storing the information received in response to the first and second requests.
